(19) United States
(12) Patent Application Publication
(10) Pub. No.: US 2002/0035545 A1
(43) Pub. Date: Mar. 21, 2002

(54) Digital contents sales method and system

(76) Inventors: Michihiro Ota, Tokyo (JP); Hiroaki Yoshida, Tokyo (JP); Hiroaki Shinada, Tokyo (JP)

Correspondence Address: Gerald T. Shekleton, Esq., Welsh & Katz, Ltd., 22nd Floor, 120 S. Riverside Plaza, Chicago, IL, 60606, US

(21) Appl. No.: 09/927,825

(22) Filed: Aug. 10, 2001

(30) Foreign Application Priority Data
Sep. 8, 2000 (JP) 273375/2000

(51) Int. Cl. G06F 17/60; H04K 1/00; H04L 9/00

(52) U.S. Cl. 705/52; 705/14

(57) ABSTRACT

Point information is sold from a vending machine. A user sends purchased point information to a data center via the Internet using a portable telephone set or a personal computer. Points corresponding to this point information are accumulated and the user can download digital contents in accordance with the accumulated points.

### BACKGROUND OF THE INVENTION

1. Field of the Invention

The present invention relates to a digital contents sales method and system, and more particularly to a digital contents sales method and a system wherein point information is sold using a vending machine and digital contents are distributed based on points that correspond to this point information.

2. Description of the Related Art

In conventional digital contents sales systems that use the Internet, settlement methods for payment include deposits made based on an invoice sent separately or payment using a credit card number.

However, the method of payment using a deposit based on an invoice sent separately requires time because the user must go to a financial institution to make the deposit and this is not sufficiently convenient for the user.

Also, in the method of payment using a credit card number, information including the credit card number is sent out on the Internet, which may cause a danger of abuse by another party, and sufficient security cannot be guaranteed.

Under such circumstances, a method and a system that allows more effective marketing of digital contents through an easy settlement method have been sought.

In Japanese Patent Application Nos. 11-280034 and 2000-210217, the inventors proposed a promotion system using a format in which point information, including encrypted points, is presented to a product purchaser when they purchase a product, and in which simple sending of the point information shown to the purchaser to a center unit via telecommunications products, such as a portable telephone set or a personal computer, the points decoded from the point information by the center unit are added, and a vendor provides the purchaser with a service to suit the added points.

### SUMMARY OF THE INVENTION

An object of the present invention is to provide a digital contents sales system with a simpler settlement method by applying the above promotion system in a digital contents sales system.

To fulfill the above object, the present invention provides a method for selling digital contents, wherein a vending machine is provided with point information presentation means that presents prescribed point information to a user of the vending machine to correspond with a sales operation based on the insertion of prescribed amount of money in the vending machine; the presented point information is sent by the user to a center unit with identification information of the user; points that correspond to the sent point information are stored and managed for the user by the center unit; and digital contents are distributed to the user upon a request from the user for distribution of desired digital contents, based on points stored and managed for this user.

The point information includes a module code relating to issue of the point information and a secret code that represents the points and, of these, at least the secret code is encrypted and presented to the user.

The point information is presented by displaying the point information on a display unit in the vending machine.

The point information is presented by printing the point information from the vending machine onto prescribed paper.

The point information is presented by transmitting the point information to communication equipment of the user through communication between the vending machine and the communication equipment.

The communication equipment comprises a portable telephone set carried by the user, and input of the point information into the communication equipment is carried out using either one of wired communication, wireless communication, infrared communication, and audio communication between the vending machine and the portable telephone set.

The point information is presented by previously attaching a printed material, onto which the point information has been printed, to a dummy product.

The secret code includes at least a point issue number, and the center unit determines whether or not the point information has been used twice based on the point issue number.

The module code comprises code information to identify the vending machine, and the center unit manages the status of the vending machine based on the module code.

The center unit manages a usage status of the user based on identification information for the user sent by the user.

Also, upon request by the user, the center unit allows perusal by the user of point stored and managed for the user.

The present invention also provides a digital contents sales system, comprising: a vending machine having point information presentation means for presenting prescribed point information to a user of the vending machine to correspond with a sales operation based on insertion of a prescribed amount of money; a center unit that stores and manages points corresponding to the point information for the user; communication means for sending the point information together with identification information for the user to the center unit; update means provided in the center unit for decrypting the point information sent using the communications means and updating the points that are stored and managed for the user by points corresponding to the point information; and digital contents distribution means for distributing digital contents to the user based on the points stored and managed for the user.

The point information includes a module code that identifies the vending machine and a secret code that relates to the points, and the point information presentation means, of the module code and the secret code, encrypts at least the secret code and presents the same to the user.

The point information presentation means presents the point information to the user by displaying the point information on a display unit provided on the vending machine.

The point information presentation means presents the point information to the user by printing the point information on a prescribed paper using printing means provided in the vending machine.

The point information presentation means presents the point information to the user by transmitting the point information to communication equipment of the user by communication between the vending machine and the communication equipment.

The communication equipment includes a portable telephone set carried by the user, and the point information presentation means presents the point information to the user by transferring the point information to the portable telephone set using either wired, wireless, infrared, or audio communication.

The point information presentation means presents the point information to the user by selling a dummy product to which a printed material on which the point information has been printed is previously attached.

The secret code includes at least a point issue number, and the center unit determines whether or not the point information has been used twice based on a point issue number included in the point information.

The center unit is provided with an equipment database that stores and manages the status of the vending machine in correspondence with the module codes.

The center unit is provided with a user database that stores and manages the usage status of the system by the user in correspondence with identification information for the user sent by the user.

The center unit is provided with perusal means that, upon a request from the user, allows the user to peruse the point stored and managed for that user.

### BRIEF DESCRIPTION OF THE DRAWINGS

FIG. 1 is a block diagram that shows an example of the configuration of the digital contents sales system of the present invention;

FIG. 2 is a block diagram that shows the vending machine shown in FIG. 1;

FIG. 3 explains the point information used in the digital contents sales system shown in FIG. 1;

FIG. 4 is a block diagram showing the configuration of the data center shown in FIG. 1; and

FIG. 5 is a flow chart showing the flow of operations in the data center shown in FIG. 1.

### DESCRIPTION OF THE PREFERRED EMBODIMENTS

Aspects of the embodiment of the digital contents sales method and system of the present invention will be explained in detail with reference to the appended diagrams.

The present invention is based on a concept in which point information that has been issued as a bonus with products being promoted in the above promotion system proposed by the inventors of the present invention is marketed as a product itself

By using a configuration in which a user views this point information as having some sort of value that allows the user to download digital contents that match this value, it is possible to simplify the payment system, which tends to be a nuisance in ordinary digital contents sales systems.

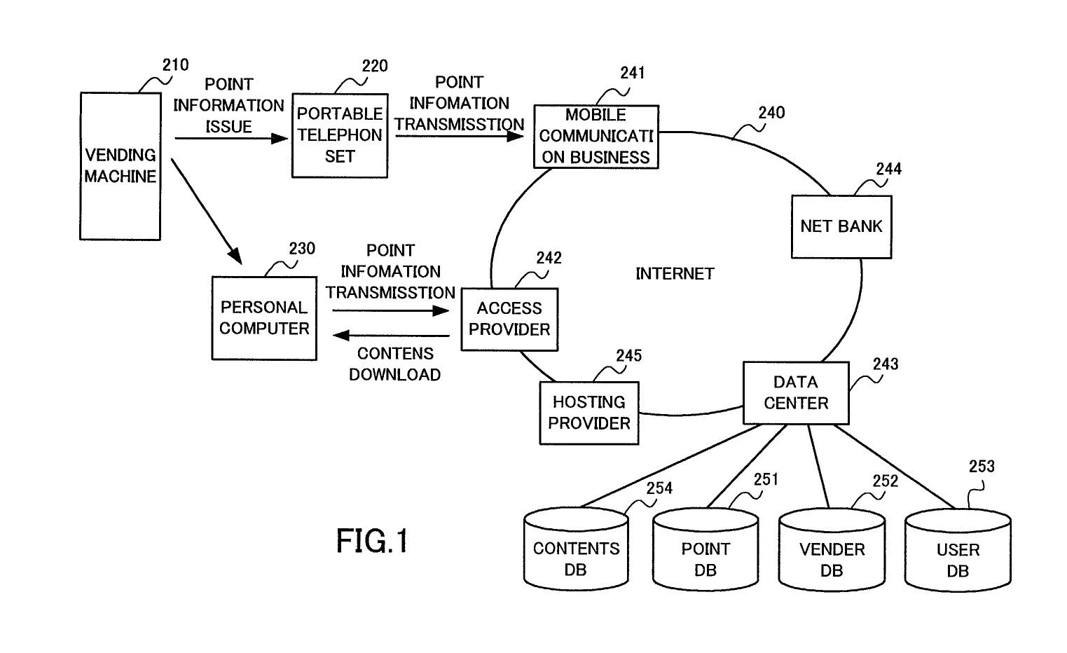

FIG. 1 is a schematic view of a system that shows one example of the configuration of the digital contents sale system of the present invention.

In the digital contents sales system shown in FIG. 1, a multiplicity of vending machines 210, located either indoors or outdoors, sell, as point information, points to suit the amount of money paid. The user can accumulate points corresponding to this point information by sending purchased point information to a data center 243. Digital contents are distributed to this user to match the points accumulated at the data center 243.

Here, the detailed configuration of the vending machine 210 will first be explained.

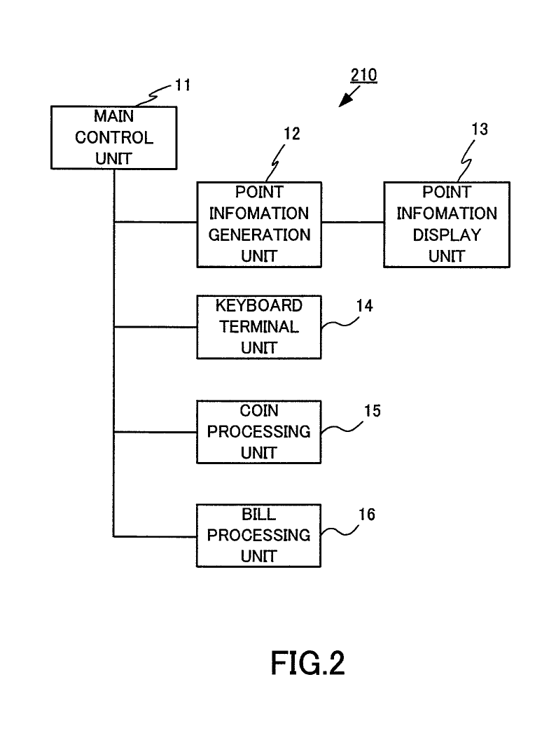

FIG. 2 is a block diagram showing the configuration of the vending machine 210 shown in FIG. 1.

As shown in FIG. 2, the vending machine 210 comprises: a main control unit 11; a point information generation unit 12; a point information display unit 13; a keyboard terminal unit 14; a coin processing unit 15; and a bill processing unit 16.

The main control unit 11 controls all the parts in the vending machine 210. In addition, based on the total amount of money inserted and a selection button (not pictured) pressed, the main control unit 11 generates a control signal that controls the issue of points to correspond to this selection button.

The point information generation unit 12 generates point information based on the control signal from the control part 11. The point information generated by this point information generation unit 12 is displayed as visible information (character string) on the point information display unit 13. It is desirable to display points corresponding to point information together with the point information on the point information display unit 13, because the user can confirm the points that they have purchased.

The keyboard terminal unit 14 implements all types of settings including the price of the point information sold. The coin processing unit 15 receives coins and returns change and the bill processing unit 16 receives bills.

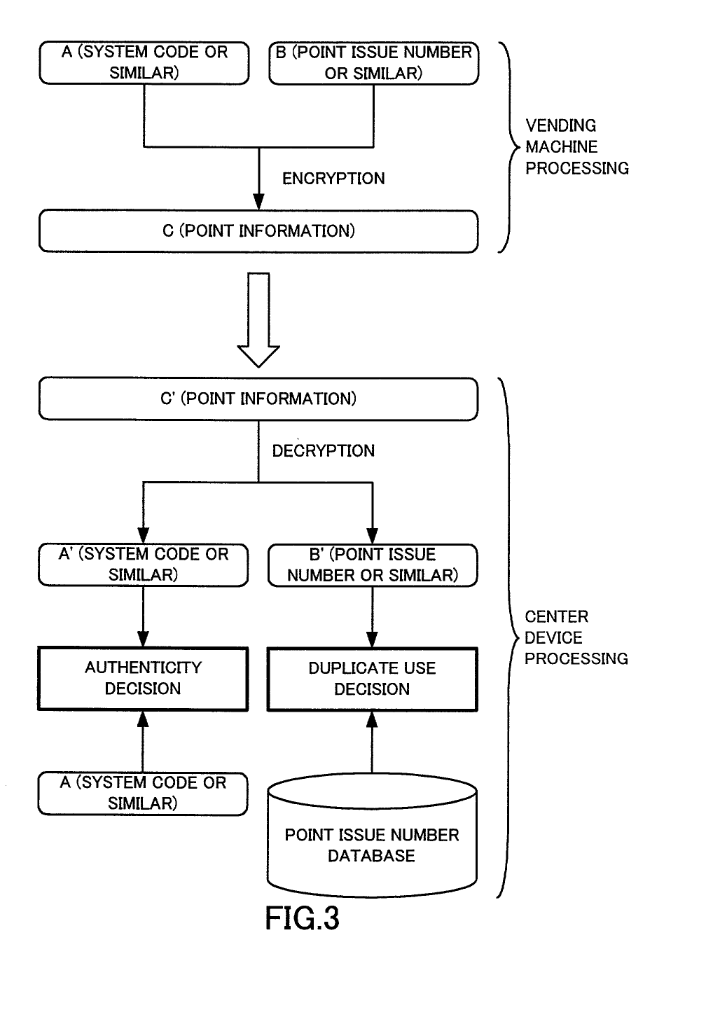

As long as its authenticity can be confirmed in the data center 243 (FIG. 1), the point information generated by the point information generation unit 12 can take any form. For example, it can be generated using the method shown in FIG. 3.

That is, as shown in FIG. 3, the point information generation unit 12 encrypts information specific to this system (a system code, etc.) A and information specific to the points issued (a point issue number, etc.) B based on a prescribed code key, generates point information C, and displays this so that it is visible in the point information display unit 13.

The purchaser then sends this displayed information C to the data center 243 via the Internet 240 using either a portable telephone set 220 or a personal computer 230.

In the data center 243 that received point information C′ (which is, if genuine, the same as point information C), information A′ and B′ are acquired using a prescribed decrypting key.

Next, the authenticity of the point information is checked (authenticity decision) by comparing information A′ with information A, which is specific to the system (a system code, etc.) and has been stored in advance in the data center 243.

Furthermore, information B′ is retrieved from the point issue number database managed by the data center 243 that then checks whether or not it has been used (duplicate use decision).

Next, the sending of point information by the portable telephone set 220 and the processing in the data center 243 will be explained.

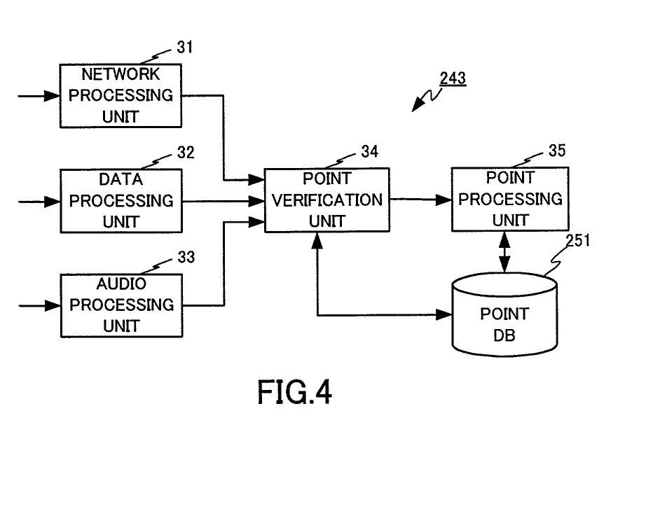

FIG. 4 is a block diagram showing the detailed configuration of the data center 243.

As shown in FIG. 4, the data center 243 comprises: a network processing unit 31; a data processing unit 32; an audio processing unit 33; a point verification unit 34; and a point processing unit 35. Furthermore, it is provided with a point database (point DB) 251 that stores and manages points purchased by a user that corresponds to a user ID.

The network processing unit 31 is connected to the Internet 240 and acquires point information from a mail server or a Web server, neither of which is pictured here.

This network processing unit 31 operates when point information is sent from e-mail or a prescribed home page, that is when point information is sent from the portable telephone set 220 or personal computer 230 linked to the Internet 240.

The data processing unit 32 acquires point information that has been sent by a special mail or data transfer method to the portable telephone set 220. That is, the data processing unit 32 operates when point information is sent from the portable telephone set 220 with a special data transfer function.

The audio processing unit 33 acquires point information sent in audio form, for example, by the voice of the purchaser or by the tones of push buttons. That is, the audio processing unit 33 operates when point information is sent from the portable telephone set 220 or an ordinary telephone, not pictured, in audio form.

The point verification unit 34 uses the above method to verify the authenticity of the point information received. When the information is verified to be genuine, another check is made to ensure that the point information is unused. This processing is conducted to ensure that the same point information is not sent a number of times accidentally by the purchaser or through abuse.

The point processing unit 35 manages, for each sender (purchaser), point information that has been verified as genuine and unused by the point verification unit 34. The number of points equating to the point information received is added to the points stored in the point DB 251.

The network processing unit 31, data processing unit 32, and audio processing unit 33 do not all have to be located within the system. When restrictions are placed on the method by which point information is sent, parts can be omitted. For example, if point information can only be sent via the Internet 240, the data processing unit 32 and audio processing unit 33 can be omitted.

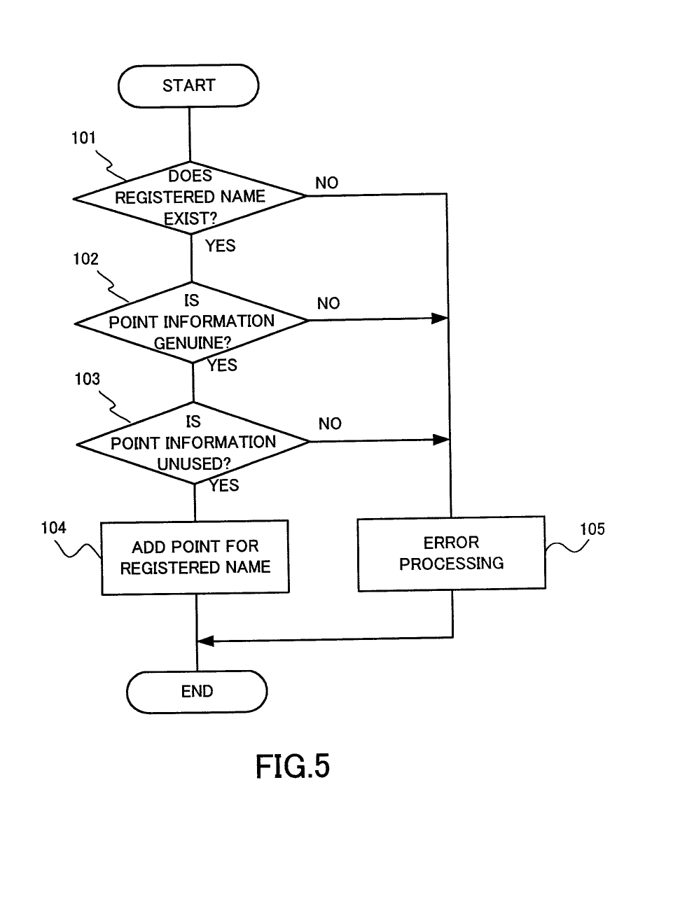

Next, the operation of the data center 243 will be explained with reference to FIG. 5.

FIG. 5 is a flow chart that shows the flow of operations in the data center 243.

In the data center 243, when point information is acquired either by the network processing unit 31, the data processing unit 32 or the audio processing unit 33, the point verification unit 34 refers to the point DB 251 and determines whether or not the registered name received with the point information (registered with the name of the sender of the point information) actually exists (step 101). If it does exist (yes in step 101), the authenticity of this point information is confirmed (step 102).

If, as a result of that confirmation, the point information is genuine (yes in step 102), the system then checks whether or not the point information is unused (step 103).

Also if, as a result of that confirmation, the point information is found to be unused (yes in step 103), the point processing unit 35 then adds number of points based on the point information received to the number of points for this registered name stored in the point DB (step 104). Processing then ends.

On the other hand, if the registered name does not actually exist (no in step 101), if the point information is false (no in step 102), or if the point information has been used more than once (no in step 103), processing ends in error processing without the points being added (step 105).

In error processing, not only are the points not added, but the number of times error processing has occurred for that registered name is calculated. If error processing has occurred more than a prescribed number of times, that registration can be deleted. Also, it may be arranged such that, if there is no such registered name, a new registration is received and processing after step 102 are executed.

In the configuration shown in FIG. 1, the vending machine 210 generates corresponding point information based on the number of points selected by the pressing of selection buttons not pictured or the insertion of money. This point information is then displayed on a display unit that is not pictured.

The above point information includes

1) a module code, and

2) a secret code.

Here, the module code identifies the above vending machine 210. Therefore, this digital contents sales system is configured so that the status of the vending machine 210 corresponding to this module code is stored and managed by the vendor database (vendor DB) 252 in the data center 243.

The secret code includes

1) a point issue number,

2) points, and

3) parity.

Here, point issue number, which is a consecutive number allocated each time point information is sold from the vending machine 210, is used to check for duplicate use of the point information and for invalid use.

In other words, if the point issue number for point information received at the data center 243 is the same as the point issue number for point information already received, that point information is deemed to have been used twice. When the point issue number for the point information received at the data center 243 is unusually distant from a point issue number for point information received previously as genuine, this point information will be deemed to be suspected of being used in an invalid manner.

Also, parity is additional information for checking that errors or alterations have not occurred in the point information during transmission from the user and in the encryption and decryption processes. Hash functions or cyclic codes can be used as this additional information.

The secret code is generated by encrypting these information using an encryption key stored previously.

The basics of the method used by a user to purchase point information from the vending machine 210 are explained below. The money is inserted, a selection button, not pictured, that corresponds to the desired number of points is pressed, the point information displayed on the display unit of the vending machine 210 is read and then stored by jotting it down as a memo, for example.

This stored point information is entered into the portable telephone set 220 carried by a user or the personal computer 230 and then sent to the data center 243 with an ID (identification information) that identifies the user and a prescribed password.

To simplify the above method, an infrared communication device is built into the vending machines 210 within this digital contents sales system. This infrared communication device is used to simplify entry of the above point information into the above portable telephone set 220.

It is also possible to provide a means of printing out the above point information in the vending machine 210.

It is also possible to provide dummy products in the vending machine 210 and to sell point information attached to them. For example, paper on which point information has been printed can be placed inside capsules of various shapes and colors. When a user presses a selection button, the vending machine 210 transports these capsules to the product chute thereof The user can then acquire the point information by opening the capsule. Configuration of the machine in a way that can be enjoyed by users has the effect of increasing the desire to buy.

It is preferable to display the point information and the number of points corresponding to that point information on the display unit of the vending machine 210 so that the user can confirm the points purchased.

When an infrared communication device is used, another display unit is provided on which the user is asked to confirm the points purchased. Also, when this is printed out, the user can check the points purchased by printing the point information and the points that correspond to that point information.

The data center 243 is built as a Web server on the Internet 240.

This data center 243 is provided with: a point database (point DB) 251 that stores and manages points purchased by a user to correspond with a user ID; a vendor database (vendor DB) 252 that stores and manages the status of vending machines 210 that correspond with the above module codes; and a user database (user DB) 253 that stores and manages individual user information and the usage status of the system by the user.

Transmission of point information from a portable telephone set 220 carried by a user to this data center 243 is carried out via the portable telephone set 220, mobile communications provider 241, and the Internet 240.

Transmission of point information from a user's personal computer 230 to the data center 243 is carried out via the personal computer 230, user's access provider 242, and the Internet 240.

When the data center 243 receives the point information from the user's portable telephone set 220 or personal computer 230, it firstly refers to the user database 253 and checks the user ID and password.

Next, it refers to the vendor database 252 and checks the module code.

Next, it decodes the secret code, checks the parity, checks the point issue number, checks the number of points, and updates the point database 251 based on the results of these checks.

This data center 243 performs:

1) management of users in accordance with user database 253 registrations and updates,

2) management of points based on the point database 251,

3) management of point issuing devices in accordance with vendor database 252 registrations and updates, and

4) management of sales information, change, and breakdowns for vending machines 210.

When the data center 243 receives the request for perusal of the stored points from the user's portable telephone set 220 or personal computer 230, it firstly refers to the user database 253 and checks the user ID and password and transmits to the user's portable telephone set 220 or personal computer 230 information (the number of points, etc.) regarding the points stored and managed in the point database 251 for this user ID. Whereby, the user can confirm how much points are accumulated for this user.

The above Internet 240 is provided with: a net bank 244 that acts as a settlement proxy for the data center 243 relating to the above points, and a hosting provider 245 that acts for the data center 243 in distributing a home page that provides marketing information to managers of vending machines 210 and distributes a home page that displays digital contents that can be sold to users.

Users access the data center 243 via the Internet 240 using a personal computer 230. The user can download the digital contents they desire from the contents DB 254 in accordance with the number of points they have accumulated, which is stored and managed in the point DB.

The contents DB 254 stores a variety of digital contents. Upon receipt of a request for contents distribution from a user, it checks the number of stored points that correspond to a user in the point DB and, based on the points available, determines whether or not the desired digital contents is within a purchasable range. If it is, it subtracts the number of points required for the digital contents from the number of points accumulated in the point DB, updates the point DB, and downloads the digital contents onto the personal computer of the user.

In the embodiments explained above, the issue of points relating to the present invention is explained as examples in which a vending machine is used. However, other equipment, such as cash registers can be used. This enables the issue of points both for products marketed in vending machines and products marketed in a shop. In particular, when a cash register is used, the point information explained in the second aspect of the embodiment above can be printed on a receipt.

What is claimed is:

1. A digital contents sales method, wherein
a vending machine is provided with point information presentation means that presents prescribed point information to a user of the vending machine to correspond with a sales operation based on the insertion of a prescribed amount of money in the vending machine;
the presented point information is sent by the user to a center unit with identification information of the user;
points that correspond to the sent point information are stored and managed for the user by the center unit; and
digital contents are distributed to the user upon a request from that user for distribution of desired digital contents, based on points stored and managed for this user.

2. The digital contents sales method according to claim 1, wherein the point information includes a module code relating to issue of the point information and a secret code that represents the points, and wherein, of these, at least the secret code is encrypted and presented to the user.

3. The digital contents sales method according to claim 1, wherein the point information is presented by displaying the point information on a display unit in the vending machine.

4. The digital contents sales method according to claim 1, wherein the point information is presented by printing the point information from the vending machine onto prescribed paper.

5. The digital contents sales method according to claim 1, wherein the point information is presented by transmitting the point information to communication equipment of the user through communication between the vending machine and the communication equipment.

6. The digital contents sales method according to claim 1, wherein the point information is presented by previously attaching a printed material, onto which the point information has been printed, to a dummy product.

7. The digital contents sales method according to claim 5, wherein the communication equipment comprises a portable telephone set carried by the user, and input of the point information into the communication equipment is carried out using wired communication, wireless communication, infrared communication, or audio communication between the vending machine and the portable telephone set.

8. The digital contents sales method according to claim 2, wherein the secret code includes at least a point issue number, and the center unit determines whether or not the point information has been used twice based on the point issue number.

9. The digital contents sales method according to claim 2, wherein the module code comprises code information to identify the vending machine, and the center unit manages the status of the vending machine based on the module code.

10. The digital contents sales method according to claim 1, wherein the center unit manages a usage status of the user based on identification information for the user sent by the user.

11. The digital contents sales method according to claim 1, wherein upon request by the user, the center unit allows perusal by the user of point stored and managed for the user.

12. A digital contents sales system, comprising:
a vending machine having point information presentation means for presenting prescribed point information to a user of the vending machine to correspond with a sales operation based on insertion of a prescribed amount of money;
a center unit that stores and manages points corresponding to the point information for the user;
communication means for sending the point information together with identification information for the user to the center unit;
update means provided in the center unit for decrypting the point information sent using the communications means and updating the points that are stored and managed for the user by points corresponding to the point information; and
digital contents distribution means for distributing digital contents to the user based on the points stored and managed for the user.

13. The digital contents sales system according to claim 12, wherein the point information includes a module code that identifies the vending machine and a secret code that relates to the points, and the point information presentation means, of the module code and the secret code, encrypts at least the secret code and presents the same to the user.

14. The digital contents sales system according to claiml2, wherein the point information presentation means presents the point information to the user by displaying the point information on a display unit provided on the vending machine.

15. The digital contents sales system according to claim 12, wherein the point information presentation means presents the point information to the user by printing the point information on a prescribed paper using printing means provided in the vending machine.

16. The digital contents sales system according to claim 12, wherein the point information presentation means presents the point information to the user by transmitting the point information to communication equipment of the user by communication between the vending machine and the communication equipment.

17. The digital contents sales system according to claim 12, wherein the point information presentation means presents the point information to the user by selling a dummy product to which a printed material on which the point information has been printed is previously attached.

18. The digital contents sales system according to claim 16, wherein the communication equipment includes a portable telephone set carried by the user, and the point information presentation means presents the point information to the user by transferring the point information to the portable telephone set using either wired, wireless, infrared, or audio communication.

19. The digital contents sales system according to claim 13, wherein the secret code includes at least a point issue number, and the center unit determines whether or not the point information has been used twice based on a point issue number included in the point information.

20. The digital contents sales system according to claim 13, wherein the center unit is provided with an equipment database that stores and manages the status of the vending machine in correspondence with the module codes.

21. The digital contents sales system according to claim 12, wherein the center unit is provided with a user database that stores and manages the usage status of the system by the user in correspondence with identification information for the user sent by the user.

22. The digital contents sales system according to claim 12, wherein the center unit is provided with perusal means that, upon a request from the user, allows the user to peruse the point stored and managed for that user.
